(19) United States
(12) Patent Application Publication
(10) Pub. No.: US 2011/0194910 A1
(43) Pub. Date: Aug. 11, 2011

(54) ASSEMBLY HAVING SCREW AND NUT

(75) Inventors: CHI-SHENG LIN, Tu-Cheng (TW); ZE-XU WANG, Shenzhen City (CN)

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/880,165

(22) Filed: Sep. 13, 2010

(30) Foreign Application Priority Data
Feb. 9, 2010 (CN) 201010112326.5

(51) Int. Cl. F16B 5/02

(52) U.S. Cl. 411/172

(57) ABSTRACT

An assembly includes a main body, a screw, a nut and a restricting tab. The main body has a slot. A first end portion of the slot is narrower than a second end portion of the slot. The screw has a head and a shank. The shank is movable along the slot. The nut is threadedly engaged with the shank, and is wider than the first end portion and narrower than the second end portion. The restricting tab can be detachably sandwiched between the nut and the main body such that the shank can be trapped in the first end portion.

### BACKGROUND

1. Technical Field

The present disclosure relates to assembly, and particularly, to a assembly including a screw and a nut.

2. Description of Related Art

During assembly of electronic products, screws are usually employed as fasteners for mounting one component to another component. And during disassembly of the electronic products, such as repairing a computer host or reassembly of the computer host, the screws need to be detached from the component. However, the screws are usually quite small and easily dropped, and can cost much time to find them. Additionally, the screws may drop into the computer host, and cause a short circuit. Therefore, an assembly configuration is desired for overcoming the shortcomings as aforementioned.

### BRIEF DESCRIPTION OF THE DRAWINGS

Many aspects of the present assembly can be better understood with reference to the following drawings. The components in the drawings are not necessarily drawn to scale, the emphasis instead being placed upon clearly illustrating the principles of the present assembly. Moreover, in the drawings, like reference numerals designate corresponding parts throughout the views.

FIG. 1 is an isometric, exploded view of an assembly in accordance with an exemplary embodiment.

FIG. 2 is an isometric, assembled view of the assembly of FIG. 1.

FIG. 3 is similar to FIG. 2, but viewed from another aspect.

FIG. 4 is an isometric, cross-sectional view of the assembly of FIG. 3, corresponding to line IV-IV.

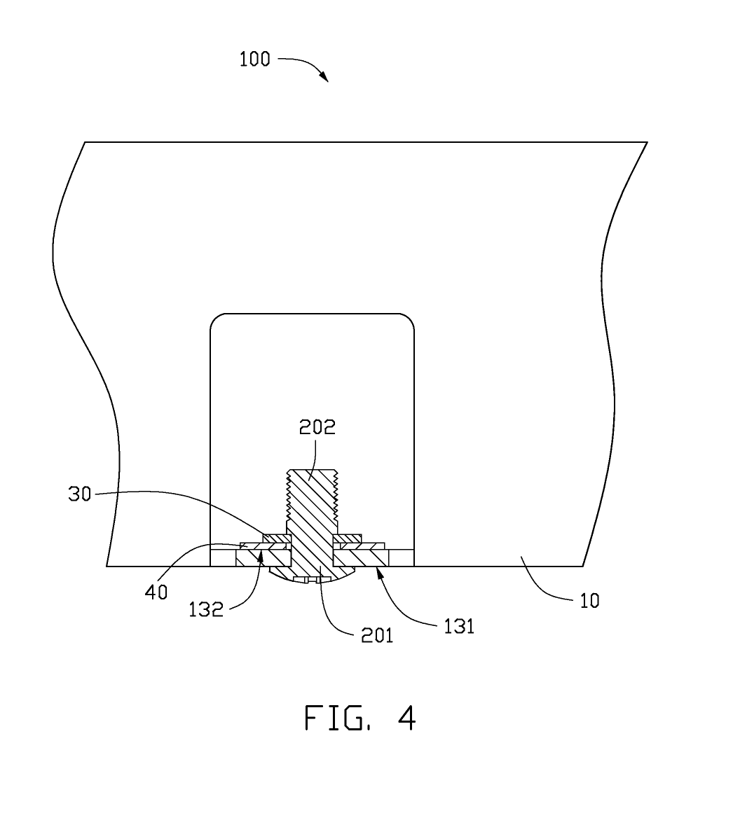

### DETAILED DESCRIPTION

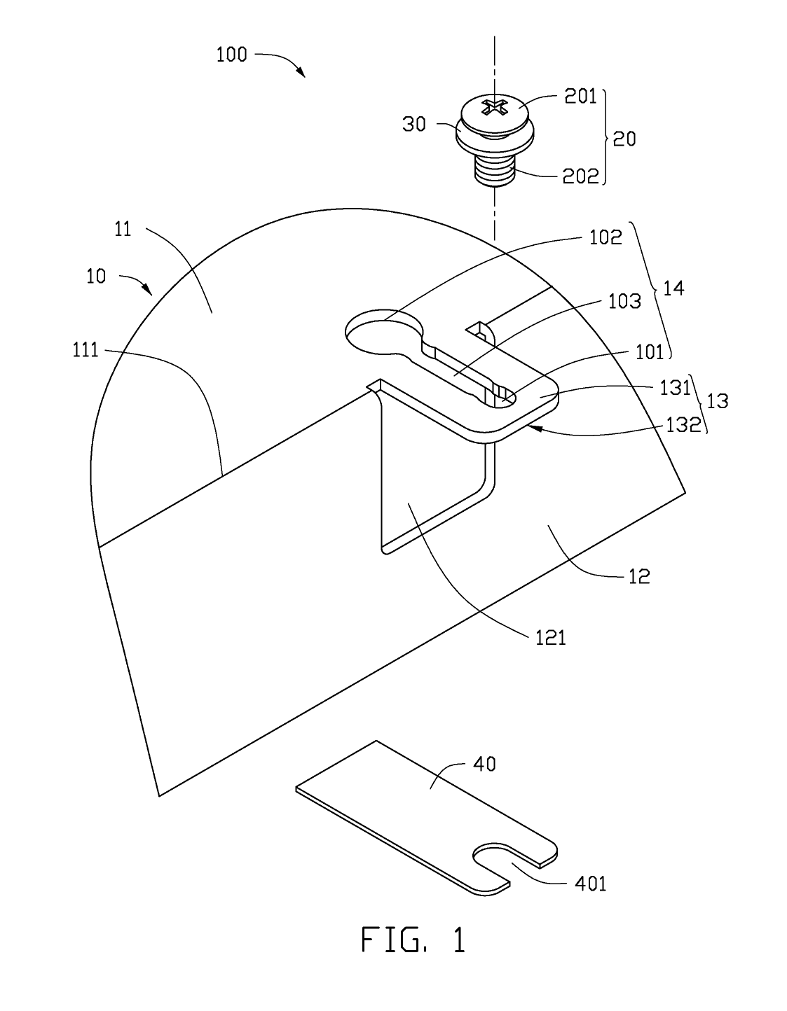

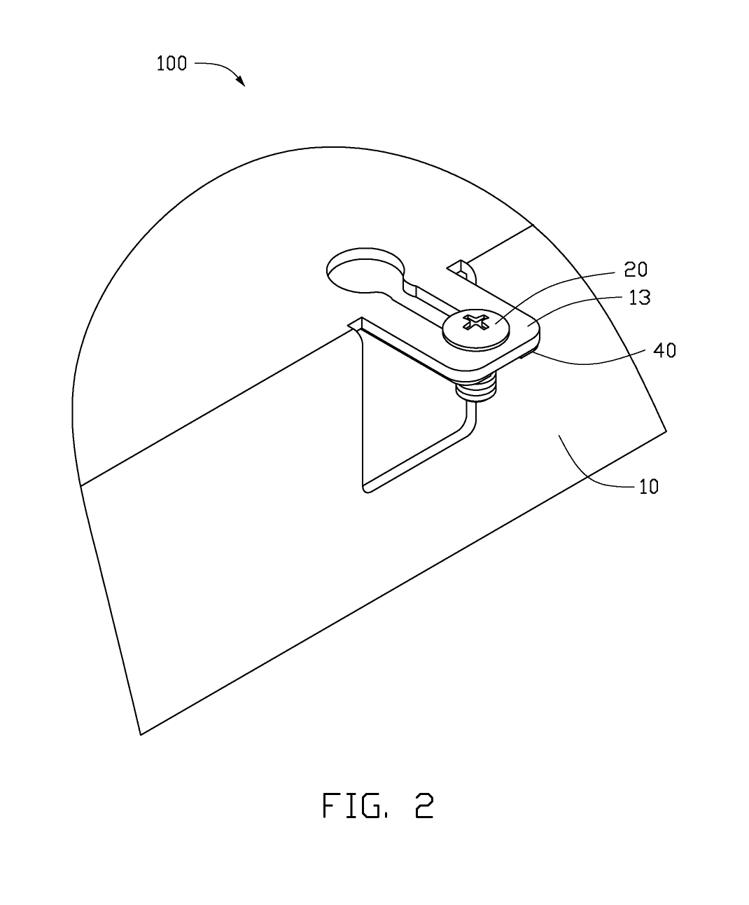

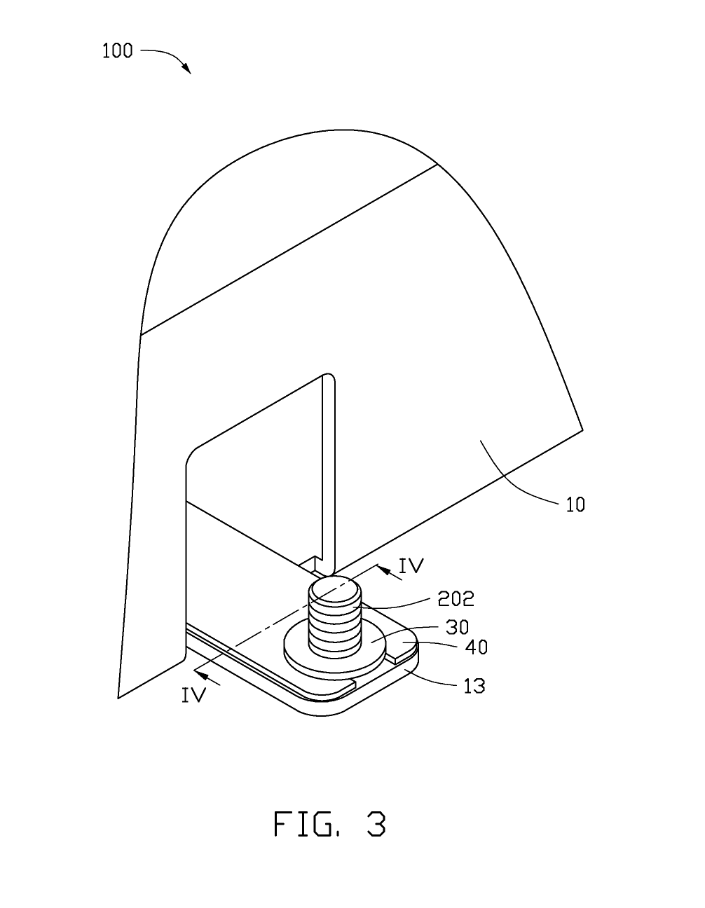

Referring to FIGS. 1-3, an exemplary assembly 100 includes a main body 10, a screw 20, a nut 30, and a restricting tab 40. The main body 10 is to be mounted onto another component. For example, the main body 10 can be a hard disk bracket to be mounted onto an inner surface of a computer host shell. In the present embodiment, the main body 10 includes a first panel 11, a second panel 12, and a fixing panel 13. The second panel 12 perpendicularly extends from an edge 111 of the first panel 11. The fixing panel 13 directly extends from the border line 111 between the first panel 11 and the second panel 12, and perpendicularly intersects with the second panel 12. In other words, the fixing panel 13 cantilevers from the second panel 12. The fixing panel 13 has a first surface 131 coplanar with a surface of the first panel 11, and a second surface 132 opposite to the first surface 131. A slot 14 is defined in the first panel 11 and the fixing panel 13. In detail, the slot 14 includes a first end portion 101, a second end portion 102, and an intermediate portion 103. The first end portion 101 and the intermediate portion 103 are defined in the fixing panel 13, and the second end portion 102 is defined in the first panel 11. The second end portion 102 is wider than either of the first end portion 101 and the intermediate portion 103. Additionally, the second panel 12 defines a restricting hole 121 extending from the border line 111 and to a central portion thereof. If bent about 90 degrees, the fixing panel 13 can be accommodated in the restricting hole 121.

The screw 20 has a slotted head 201 and a threaded shank 202 extending through the first end portion 101 of the slot 14. The head 201 is wider than either of the first end portion 101 and the intermediate portion 103, and narrower than the second end portion 102. The shank 202 is narrower than the first end portion 101. The shank 202 is movable along the slot 20. The nut 30 is threadedly engaged with the shank 20 at a side of the fixing panel 13 opposite to the head 201 of the screw 20. The nut 30 is wider than the first end portion 101 but narrower than the second end portion 102. As such, when the shank 202 moves from the first end portion 101 to the second end portion 102, the screw 20 can be removed by from the slot 14.

The restricting tab 40 is a rectangular panel having a restricting hole 401 in an end portion thereof. The restricting tab 40 is detachably sandwiched between the nut 30 and the fixing panel 13 with the shank 202 extending through the restricting hole 401. As such, the shank 202 can be trapped in the first end portion 101 and kept from moving into the second end portion 102.

During assembly, the screw 20 is firstly threadedly engaged with the nut 30. And then, the screw 20 is put into the second end portion 102 of the slot 20 with the head 201 and the nut 30 respectively at two opposite sides of the fixing panel 13, and moved along the slot 14 until it reaches the first end portion 101. The head 201 is pressed to contact the first surface 131 of the fixing panel 13. The restricting tab 40 is fixed on the second surface 132 in a manner that traps or engages the shank 202 by cooperation of the restricting hole 401 and the first end portion 101. The nut 30 is rotated along the shank 202 until the restricting tab 40 is firmly sandwiched between the fixing panel 13 and the nut 30. Thereafter, the shank 202 can be threadedly mounted on another component. During disassembly, since it is restricted by the restricting tab 40 and the fixing panel 13, the screw 20 cannot be separated from the fixing panel 13 and dropped. Therefore, the shortcomings are overcome.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An assembly, comprising:
a main body comprising a slot, the slot having a first end portion and an opposing second end portion, the first end portion being narrower than the second end portion;
a screw comprising a head and a shank, the shank extending through the first end portion;
a nut threadedly engaged with the shank at an opposite side of the main body to the head, the nut being wider than the first end portion and narrower than the second end portion; and
a restricting tab detachably sandwiched between the nut and the main body, the restricting tab be configured for trapping the shank in the first end portion.

2. The assembly of claim 1, wherein the slot further comprises an intermediate portion between the first and second end portions, and the intermediate portion is wider than the shank.

3. The assembly of claim 1, wherein the main body comprises a first panel, a second panel perpendicularly extending from the first panel and a fixing panel extending from the first panel perpendicular to the second panel, the slot extends from the fixing panel to the first panel, the first end portion of the slot is defined in the fixing panel, and the second end portion is defined in the first panel.

4. An assembly, comprising:
a housing including a top panel, a side panel depending from the top panel, and a fixing plate portion extending from a border line between the top panel and the side panel, the housing defining a slot extending from the top panel to the fixing plate portion, the slot having a first end portion located in the fixing plate, an opposite second end portion located in the top panel, and an intermediate portion between the first and second end portions;
a screw having a head and a shank, the shank being movable in and along the slot; and
a nut threadedly engaged with the shank, the nut being passable through the second end portion and non-passable through the first end portion, the nut and the head located at opposite sides of the fixing plate portion.

5. The assembly of claim 4, further comprising a restricting tab sandwiched between the nut and the fixing plate, the restricting tab having a bifurcated portion configured for trapping the shank in the first end portion.

6. The assembly of claim 4, wherein the top panel and the fixing plate portion are coplanar.

7. The assembly of claim 6, wherein the top panel is perpendicular to the side panel.

8. The assembly of claim 5, wherein the side panel defines a through hole with the restricting tab extending into the housing therethrough.
